(19) United States
(12) Patent Application Publication
(10) Pub. No.: US 2024/0342825 A1
(43) Pub. Date: Oct. 17, 2024

(54) OPTICAL APPARATUS

(71) Applicant: KATAOKA CORPORATION, Kyoto (JP)

(72) Inventors: Masami SUZUKI, Fujisawa-shi, Kanagawa (JP); Shoichi IMURA, Kyoto-shi, Kyoto (JP); Shinichi NAKASHIBA, Kyoto-shi, Kyoto (JP)

(73) Assignee: KATAOKA CORPORATION, Kyoto (JP)

(21) Appl. No.: 18/292,112

(22) PCT Filed: Jun. 9, 2022
(86) PCT No.: PCT/JP2022/023272

§ 371 Date: Jan. 25, 2024

(30) Foreign Application Priority Data
Dec. 1, 2021 (JP) 2021-195789

(51) Int. Cl. B23K 26/042; B23K 26/08

(52) U.S. Cl. CPC B23K 26/042; B23K 26/0876

(57) ABSTRACT

In order to implement a stage device for an optical instrument capable of accurately directing the optical instrument to a desired target position on an object supported by a moving stage, a stage device 2 for an optical instrument includes a table 22 configured to support an object and to move together with the object to cause an optical instrument 1 to be directed to any portion of the object; and a detection mechanism configured to detect a deviation between a target position to which the optical instrument 1 is to be directed on the object supported by the table 22 and a position to which the optical instrument 1 is actually directed.

### TECHNICAL FIELD

The present disclosure relates to an optical apparatus including a stage device for supporting and moving an object and causing an optical instrument to be directed to any portion of a surface of the object.

### BACKGROUND ART

In order to direct an optical instrument, for example, a laser irradiation device, a microscope, or the like (a laser optical axis, an objective lens, or the like thereof) to any portion of a processing object or an observation object (a workpiece), a mode may be adopted in which the object is supported by an XY stage (an XY table) independent from the optical instrument, and the object is relatively moved in an X-axis direction and a Y-axis direction by the XY stage (for example, see the following Patent Literature).

In the XY stage, an X-axis stage part is supported on a base (or a stand or a surface plate) and a Y-axis stage part is supported on the X-axis stage part. The X-axis stage part is movable in the X-axis direction relative to the base, and the Y-axis stage part is movable in the Y-axis direction relative to the X-axis stage part. Further, a table is provided on the Y-axis stage part, and an object is placed on the table.

Current position coordinates of the X-axis stage part and the Y-axis stage part are measured in real time via a known linear scale (or linear encoder) or the like. Then, the stage is subjected to feedback control (or servo control) to reduce a deviation between the position coordinates and target coordinates.

However, in reality, the base, the X-axis stage part, the Y-axis stage part, the table, and the like expand, contract or deform due to temperature change or aging. As a result, if a position of the stage itself is only feedback controlled, a slight displacement may occur between a target position on the object and a position to which the optical instrument is actually directed. In processing or the like for forming many fine holes by irradiating an object with a laser beam, since it is required to reduce a tolerance to 1 μm or less, a slight displacement in laser irradiation position may be a problem.

### CITATION LIST

### Patent Literature

Patent Literature 1: JP 2015-054330 A

### SUMMARY OF INVENTION

### Technical Problem

An object of the present disclosure is to enable an optical instrument to be accurately directed to a desired target position on a surface of an object supported by a moving stage.

### Solution to Problem

the present disclosure provides an optical apparatus including an optical instrument; a stage device including: a table configured to support an object and to move together with the object to cause the optical instrument to be directed to any portion of a surface of the object; and a detection mechanism configured to detect a deviation between a target position to which the optical instrument is to be directed on the object supported by the table and a position to which the optical instrument is actually directed.

The optical instrument generally refers to an instrument that obtains some effects by utilizing an action and properties of light. Specific examples of the optical instrument include a laser processing machine or a processing device that irradiates a desired position on an object with a laser beam, a microscope or a camera for observing or imaging the desired position on the object, and an analyzation device that irradiates a desired position on the object with a light beam and receives reflected light thereof.

The detection mechanism may include: for example, a scale provided in the optical instrument and extending in a direction parallel to a moving direction of the table; and a detection head provided on the table and configured to read a position on the scale.

In a case where table is movable in two-dimensional directions including an X-axis direction and a Y-axis direction (intersecting, (in particular, orthogonal to) an X-axis), the scale may include an X-axis scale extending in the X-axis direction and a Y-axis scale extending in the Y-axis direction, and the detection head may include an X-axis detection head supported to be relatively displaceable in the Y-axis direction with respect to the table and configured to read a position on the X-axis scale by facing the X-axis scale, and a Y-axis detection head supported to be relatively displaceable in the X-axis direction with respect to the table and configured to read a position on the Y-axis scale by facing the Y-axis scale.

The X-axis detection head is, for example, supported by a Y-axis block that is fixed to the table and moves along a Y-axis rail extending in the Y-axis direction. Similarly, the Y-axis detection head is supported by an X-axis block that is fixed to the table and moves along an X-axis rail extending in the X-axis direction. Due to intervention of the mechanism including the rails and the blocks, a displacement around the Z-axis (intersecting (in particular, orthogonal to) the X-axis and the Y-axis) may occur between the scale and the detection head. In order to detect the displacement, it is preferable that a Y-axis reference plane extending in the Y-axis direction and an X-axis reference plane extending in the X-axis direction are set on the table, and the detection mechanism further includes an X-axis displacement measurement mechanism configured to measure a distance between the Y-axis block and the Y-axis reference plane, and a Y-axis displacement measurement mechanism configured to measure a distance between the X-axis block and the X-axis reference plane.

However, the optical apparatus according to the present disclosure includes a control device configured to operate the table to reduce a deviation between a target position to which the optical instrument is to be directed on the object supported by the table and a position to which the optical instrument is actually directed.

The optical instrument may include, for example, a scanning device configured to irradiate any portion of a surface of the object with the laser beam, and adjust a position on the object to which the laser beam is directed by displacing an optical axis of the laser beam, and the stage device further includes a control device configured to operate the scanning device to reduce a deviation between a target position to which the optical instrument is to be directed on the object supported by the table and a position to which the optical instrument is actually directed.

### Advantageous Effects of Invention

According to the present disclosure, the optical instrument can be accurately directed to the desired target position on a surface of the object supported by the moving stage.

### BRIEF DESCRIPTION OF DRAWINGS

FIG. 1 is a perspective view showing an overall configuration of a laser processing machine according to an embodiment of the present disclosure.

FIG. 2 is a perspective view showing a laser irradiation device and a table in the embodiment.

FIG. 3 is a perspective view showing a table in the embodiment.

FIG. 4 is a side view showing the laser irradiation device and the table in the embodiment.

FIG. 5 is a diagram showing an optical system of the laser irradiation device in the embodiment.

FIG. 6 is a side view showing an attachment structure of a scale and a scale arm in the embodiment.

FIG. 7 is an A-A cross-sectional view showing details of the attachment structure of the scale arm in the embodiment.

FIG. 8 is a perspective view showing an attachment structure of a reflection plate in the embodiment.

FIG. 9 is an exploded perspective view showing an attachment structure of the reflection plate in the embodiment.

FIG. 10 is a diagram showing a configuration of a control device in the embodiment.

FIG. 11 is a flowchart showing an example of a procedure of processing to be executed by the control device of the embodiment according to a program.

### DESCRIPTION OF EMBODIMENTS

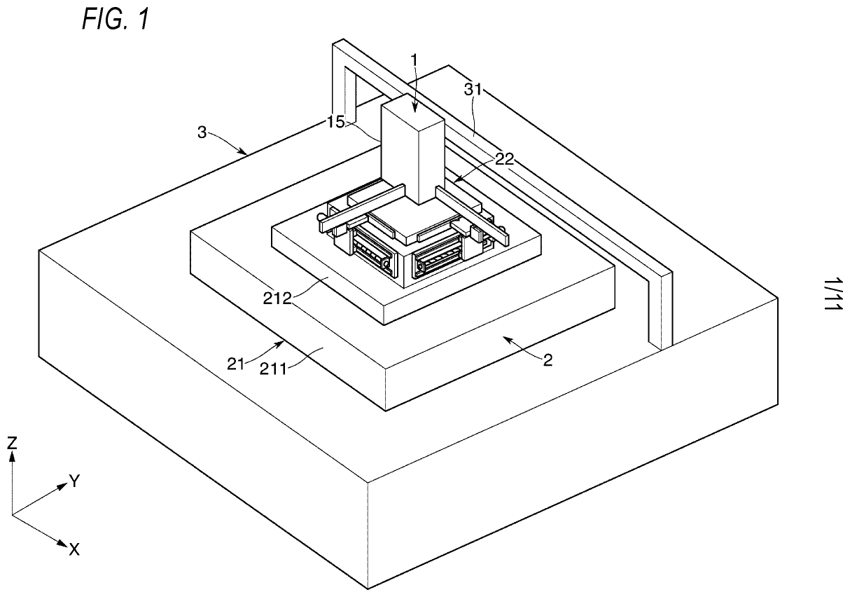

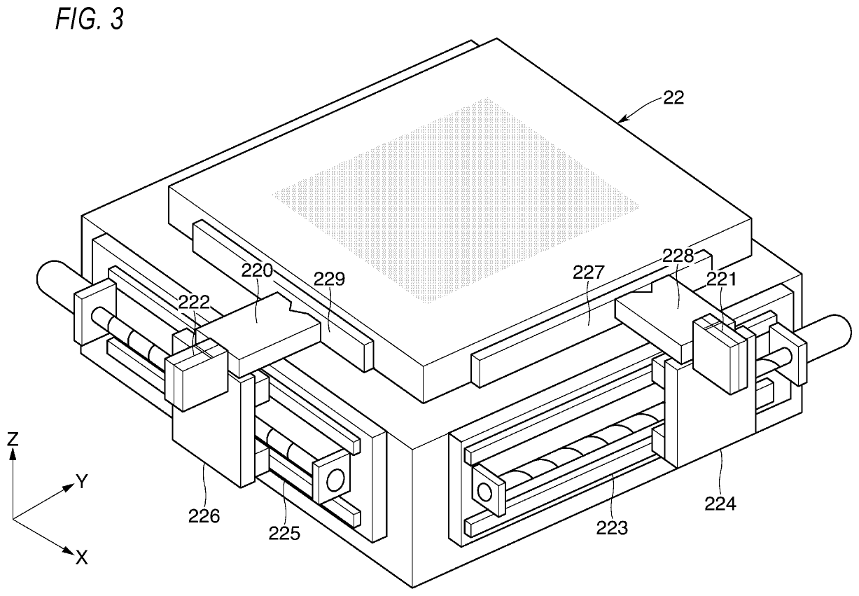

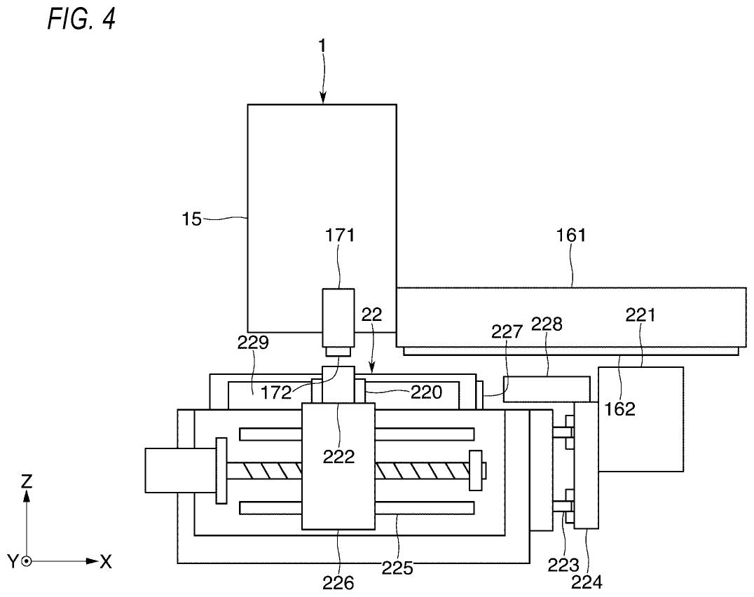

An embodiment of the present disclosure will be described with reference to the drawings. The present embodiment shown in FIGS. 1 to 11 is a laser processing machine (optical apparatus) used for performing desired machining or processing on an object (workpiece) by irradiating any portion of a surface of the object with a laser beam. The laser processing machine mainly includes a laser irradiation device 1 as an optical instrument and a stage device 2 on which an object is placed.

The laser irradiation device 1 is supported by a base 3 (or a stand or a surface plate) of a laser processing machine via a frame 31. The base 3 is grounded to a floor surface via a vibration prevention member. The vibration prevention member is, for example, a passive suspension such as a vibration prevention (vibration control) rubber or an air spring, and functions to prevent transmission of vibration having a frequency higher than a predetermined value from the floor surface to the base 3.

The laser irradiation device 1 is fixed with respect to the base 3, and does not move in an X-axis direction and a Y-axis direction which are horizontal or substantially horizontal directions. Here, the Y axis intersects (in particular, is orthogonal to) the X axis. However, as to be described later, a portion including a processing nozzle (processing head) 14 facing the object may be displaced in a vertical or substantially vertical Z-axis direction. The Z axis intersects (in particular, is orthogonal to) each of the X axis and the Y axis.

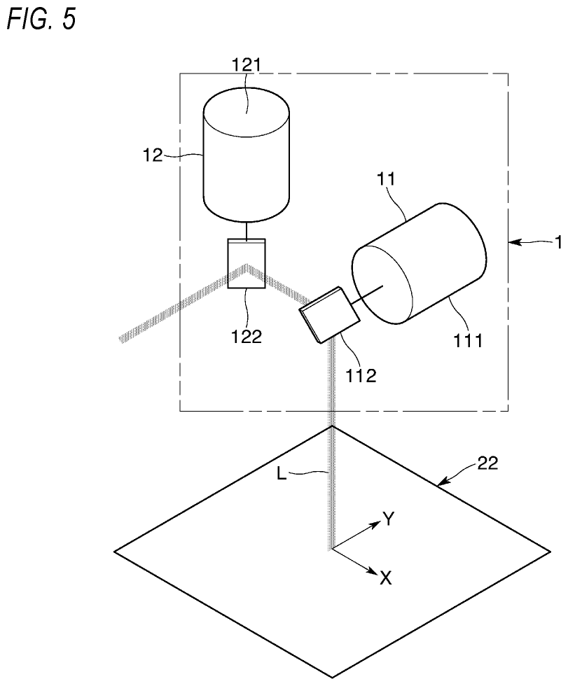

As shown in FIG. 5, the laser irradiation device 1 includes an oscillator (not shown) which is a laser beam Light source, Galvano scanners graphs 11 and 12 that are scanning devices each for displacing an optical axis of a laser beam L oscillated from the laser oscillator, and an objective lens (or a converging lens) 13 for converging the laser beam L and irradiating 5 an object with the laser beam L, and emits the laser from the processing nozzle 14.

In the Galvano scanners 11 and 12, mirrors 112 and 122 for reflecting the laser beam L are rotated by servo motors, stepping motors, and the like 111 and 121, and the optical axis of the laser beam L can be changed. In the present embodiment, both the X-axis Galvano scanner 11 that changes the optical axis of the laser beam L to the X-axis direction and the Y-axis Galvano scanner 12 that changes the optical axis of the laser beam L to the Y-axis direction are provided, and a position irradiated with the laser beam L on the object can be controlled in two-dimensional directions of the X-axis and the Y-axis. The objective lens 13 is, for example, an Fθ lens or a telecentric lens. The laser irradiation device 1 may include optical elements other than those described above, for example, an optical fiber, a cylindrical lens, a polarization plate, a beam splitter, and the like through which the laser beam L passes.

The stage device 2 can move the object in the X-axis direction and the Y-axis direction relative to the laser irradiation device 1 while supporting the object. The stage device 2 includes an XY stage (XY table) 21 and a table 22 supported by the XY stage 21.

As shown in FIG. 1, the XY stage 21 includes an X-axis stage part 211 supported by the base 3 and movable in the X-axis direction relative to the base 3, and a Y-axis stage part 212 supported by the X-axis stage part 211 and movable in the Y-axis direction relative to the X-axis stage part 211. Each of the X-axis stage part 211 and the Y-axis stage part 212 is driven by, for example, a known linear motor truck (not shown). Current position coordinates of each of the X-axis stage part 211 and the Y-axis stage part 212 are actually measured in real time using a known linear scale (or a linear encoder) or the like (not shown).

The table 22 is provided on the Y-axis stage part 212. That is, the table 22 supporting the object is moved in two-dimensional directions of the X axis and the Y axis relative to the base 3 and the laser irradiation device 1 (and the laser beam L emitted from the laser irradiation device 1) by the XY stage 21. The table 22 is made of, for example, super invar or the like (an alloy of iron, nickel, and cobalt, a metal material with an extremely small coefficient of thermal expansion (or coefficient of linear expansion) at room temperature. Also called super constant iron, super constant steel, and super amber). The object is held on the table 22 by an appropriate means other than suction and clamping.

The laser irradiation device 1, and the XY stage 21 and table 22 are not mechanically connected to each other (except for being supported by the base 3) and are independent of each other. In addition, in the present embodiment, in order to accurately adjust the position of the object with respect to the laser irradiation device 1, a detection mechanism for relative position is interposed between the laser irradiation device 1 and the table 22.

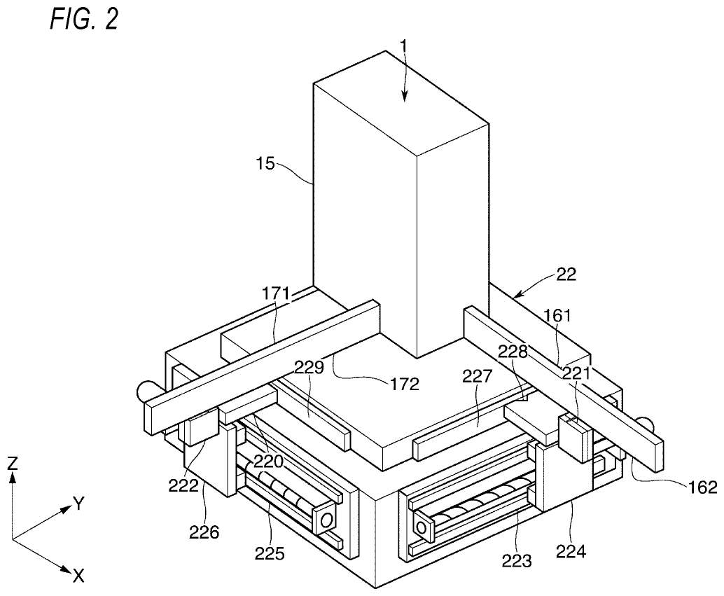

Hereinafter, the detection mechanism will be described in detail. The detection mechanism includes an X-axis scale 162, a Y-axis scale 172, an X-axis detection head 221, and a Y-axis detection head 222. As shown in FIGS. 2 to 4, the X-axis scale 162 extending in parallel to the X-axis direction and the Y-axis scale 172 extending in parallel to the Y-axis direction are provided in a case (housing) 15 of the laser irradiation device 1. Specifically, the X-axis scale 162 is attached to a lower surface side of an arm 161 which is fixed with respect to the case 15 and extends in the X-axis direction, and the Y-axis scale 172 is attached to a lower surface side of an arm 171 which is fixed with respect to the case 15 and extends in the Y-axis direction. The case 15 and the arms 161 and 171 are made of, for example, a super invar material. The X-axis scale 162 and the Y-axis scale 172 are, for example, known magnetic scales.

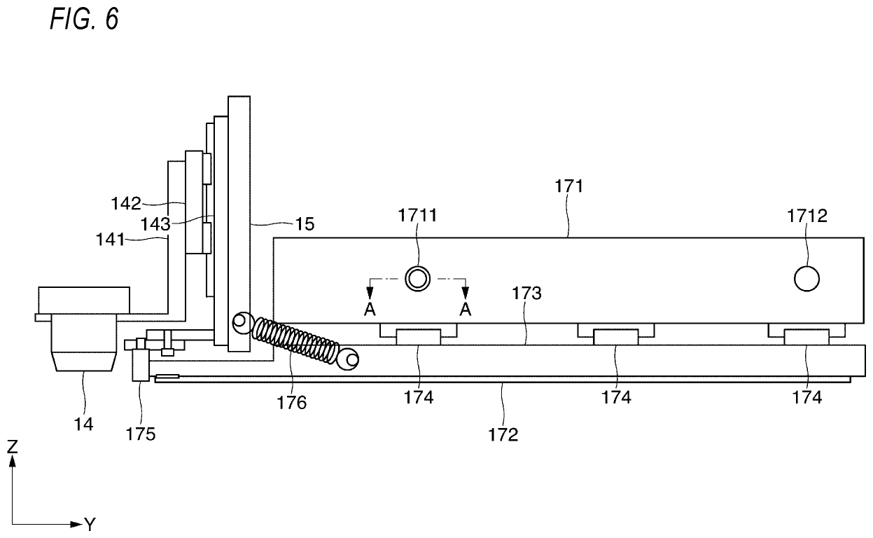

FIG. 6 shows details of an attachment structure of each of the scales 162 and 172. FIG. 6 shows the attachment structure of the Y-axis scale 172. The processing nozzle 14 that emits the laser beam L toward the object is supported by a nozzle bracket, and the nozzle bracket is supported by a Z-axis support 142. The Z-axis support 142 is supported by a Z-axis base 143 and is displaceable along the Z-axis direction relative to the Z-axis base 143. The Z-axis base 143 is fixed with respect to the case 15. A reference rod 175 is fixed with respect to the Z-axis base 143.

The linear scale 172 is bonded to a lower surface of a scale attachment base 173. The scale attachment base 173 has a tip end abutted against the reference rod 175, and is suspended from the scale arm 171 via linear guides 174. Each of the linear guides 174 allows the scale attachment base 173 to be displaced relative to the scale arm 171 along an extending direction of the linear guide 174 (the Y-axis direction in FIG. 6). A pre-pressure spring 176 is interposed between the linear guides 174 and the case 15.

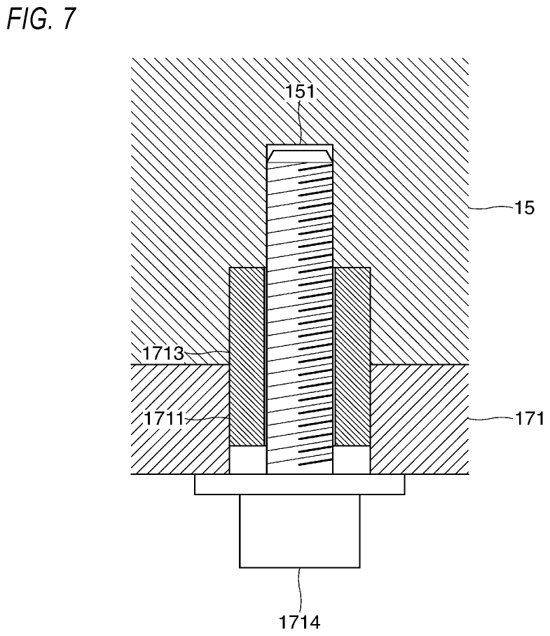

A plurality of attachment holes 1711 and 1712 are bored in the scale arm 171. A screw 1714 is inserted into each of the attachment holes 1711 and 1712, and the screw 1714 is screwed and fastened into a nut hole 151 formed in the case 15. As shown in an A-A cross-sectional view of FIG. 7, a collar 1713 is tightly fitted into one of the attachment holes 1711 and the nut hole 151. In a state where the screw 1714 inserted into the collar 1713 is loosened, the scale arm 171 and the scale attachment base 173 are adjusted to be parallel to a moving direction of the XY stage 21 and the table 22, and then the screw 1714 inserted into each of the attachment holes 1711 and 1712 is tightened.

Meanwhile, the table 22 is provided with the X-axis detection head 221 facing the X-axis scale 162 and the Y-axis detection head 222 facing the Y-axis scale 172. The X-axis detection head 221 reads position coordinates on the X-axis scale 162 along the X-axis direction. The Y-axis detection head 222 reads position coordinates on the Y-axis scale 172 along the Y-axis direction.

The X-axis detection head 221 is supported so as to be relatively displaceable along the Y-axis direction with respect to the table 22. More specifically, the table 22 is provided with a Y-axis linear guide 223 and 224, and the X-axis detection head 221 is attached to the linear guide block 224. In the Y-axis linear guide, the Y-axis block 224 is moved by a ball screw feeding mechanism or the like along the Y-axis rail 223 fixed to the table 22 and extending in the Y-axis direction. When the table 22 moves in the Y-axis direction, the Y-axis block 224 supporting the X-axis detection head 221 moves in a direction opposite to that of the table 22 along the Y-axis direction with respect to the table 22. Accordingly, the X-axis detection head 221 is constantly positioned directly below the X-axis scale 162.

Due to the intervention of the Y-axis linear guide 223 and 224, a displacement (torsion) about the Z-axis may occur between the X-axis scale 162 and the X-axis detection head 221. In order to detect the displacement, in the present embodiment, a Y-axis reference plane extending in the Y-axis direction is set on the table 22, and an X-axis displacement measurement mechanism 227 and 228 that measures a distance between the Y-axis reference plane and the Y-axis block supporting the X-axis detection head 221 is configured. The X-axis displacement measurement mechanism includes, for example, the reflection plate 227 disposed on the Y-axis reference plane and a laser displacement meter (distance gauge) 228 attached to the Y-axis block 224. The laser displacement meter 228 measures a distance between the reflection plate 227 and the laser displacement meter 228, and further a distance between the Y-axis reference plane and the X-axis detection head 221, by emitting a laser beam and receiving reflected light that hits the reflection plate 227 and is reflected.

The Y-axis detection head 222 is supported to be relatively displaceable along the X-axis direction with respect to the table 22. More specifically, the table 22 is provided with an X-axis linear guide 225 and 226, and the Y-axis detection head 222 is attached to the linear guide block 226. In the X-axis linear guide, the X-axis block 226 is moved by a ball screw feeding mechanism or the like along the X-axis rail 225 fixed to the table 22 and extending in the X-axis direction. When the table 22 moves in the X-axis direction, the X-axis block 226 supporting the Y-axis detection head 222 moves in a direction opposite to that of the table 22 along the X-axis direction with respect to the table 22. Accordingly, the Y-axis detection head 222 is normally positioned directly below the Y-axis scale 172.

Due to the intervention of the X-axis linear guide 225 and 226, a displacement (torsion) about the Z-axis may occur between the Y-axis scale 172 and the Y-axis detection head 222. In order to detect the displacement, in the present embodiment, an X-axis reference plane extending in the X-axis direction is set on the table 22, and a Y-axis displacement measurement mechanism 229 and 220 that measures a distance between the X-axis reference plane and the X-axis block 226 supporting the Y-axis detection head 222 is configured. The Y-axis displacement measurement mechanism includes, for example, the reflection plate 229 disposed on the X-axis reference plane and a laser displacement meter 220 attached to the X-axis block. The laser displacement meter 220 measures a distance between the reflection plate 229 and the laser displacement meter 220, and further a distance between the X-axis reference plane and the Y-axis detection head 222, by emitting a laser beam and receiving reflected light that hits the reflection plate 229 and is reflected.

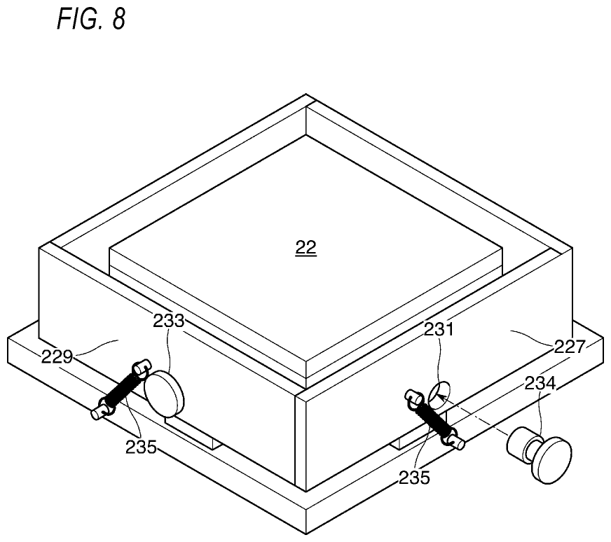

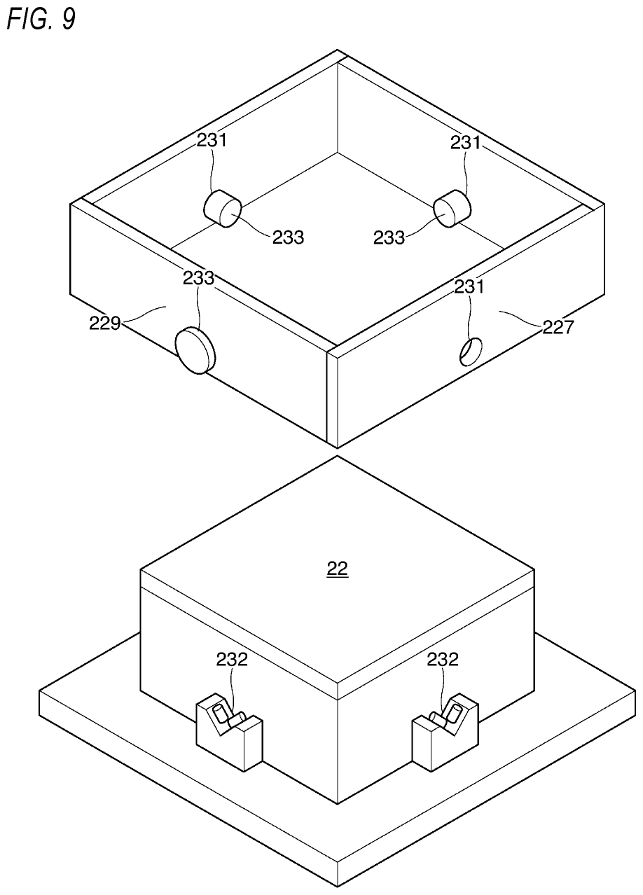

FIGS. 8 and 9 show details of an attachment structure of the reflection plates 227 and 229. The reflection plates 227 and 229 have a four-sided frame shape surrounding the table 22. A through hole 231 is formed in a center of each of the four side walls. Support rods 233 and 234 inserted through the through holes 231 are supported by rod receivers 232 provided on an outer periphery of the table 22. Each of the rod receivers 232 includes bearing rollers arranged in a V-shape. A pre-pressure spring 235 is interposed between the table 22 and a frame configured by the reflection plates 227 and 229.

Three of the four support rods 233 are tightly fitted into the through holes 231. However, a part of a shaft of the remaining support rod 234 is reduced in diameter, and a gap between the support rod 234 and the through hole 231 is increased. After the three support rods 233 are placed on the rod receivers 232, positions of the reflection plates 227 and 229 with respect to the table 22 are adjusted, and the last support rod 234 is incorporated. Gaps are formed between inner side surfaces of the reflection plates 227 and 229 and outer side surfaces of the table 22, and even if the table 22 expands or contracts due to a change in temperature, a state in which a center of the reflection plates 227 and 229 matches a center of the table 22 is maintained, and the positions of the reflection plates 227 and 229 do not change.

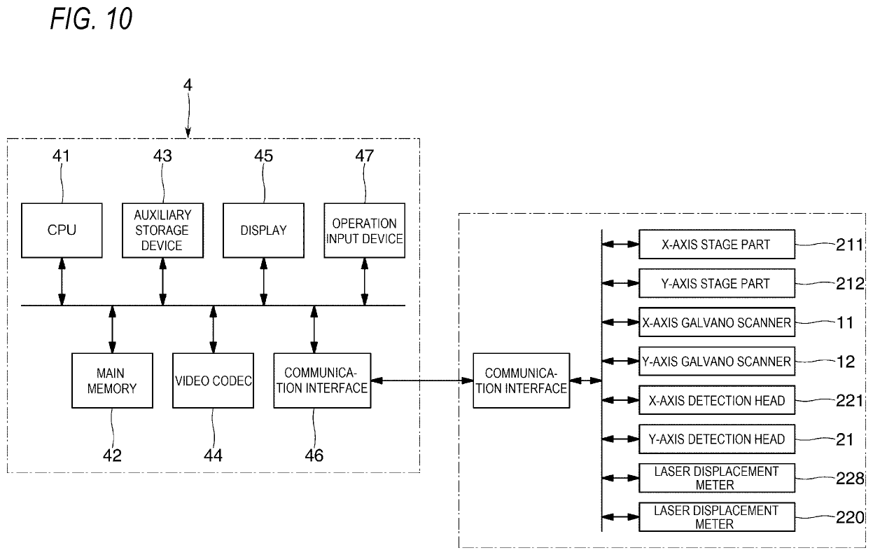

A control device 4 that controls the laser processing machine mainly includes, for example, a general-purpose personal computer, a workstation, or the like. As shown in FIG. 10, the control device 4 includes hardware resources such as a central processing unit (CPU) 41, a main memory 42, an auxiliary storage device 43, a video codec 44, a display 45, a communication interface 46, and an operation input device 47, and the hardware resources cooperate with one another.

The auxiliary storage device 43 is a flash memory, a hard disk drive, an optical disk drive, or the like. The video codec 44 includes a graphic processing unit (GPU) that generates a screen to be displayed based on a drawing instruction received from the CPU 41 and sends a screen signal to the display 45, a video memory that temporarily stores the screen or data of the image, and the like. The video codec 44 may be implemented as software instead of hardware. The communication interface 46 is a device for the control device 4 to perform information communication with an external device. The operation input device 47 is a pointing device operated by an operator with fingers, such as a keyboard, a press button, a joystick (control stick), a mouse, a touch panel (which may be superimposed on the display 45), or other devices.

In the control device 4, a program to be executed by the CPU 41 is stored in the auxiliary storage device 43, and when the program is to be executed, the program is read from the auxiliary storage device 43 into the main memory 42 and decoded by the CPU 41. The control device 4 operates the hardware resources according to the program to control the laser processing machine.

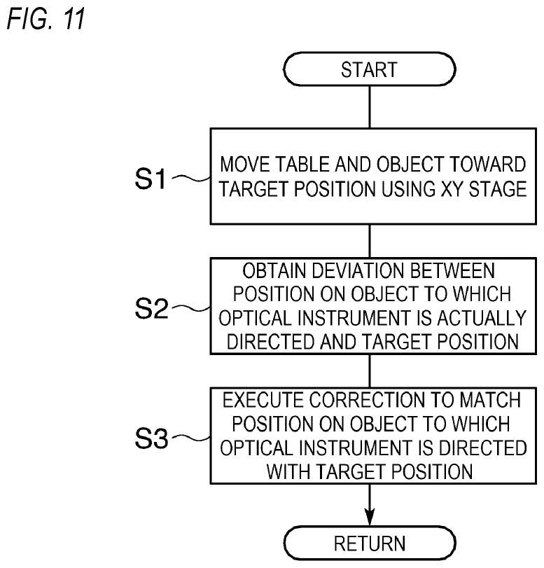

FIG. 11 shows an example of a procedure of processing performed by the control device 4 during laser processing of the laser processing machine. First, the control device 4 provides a control signal to the XY stage 21 in preparation for irradiating a target position on the object with the laser beam L from the laser irradiation device 1, and drives the XY stage 21 to move the table 22 and the object in the X-axis direction and/or the Y-axis direction such that a position on the object to which the optical axis of the laser beam L emitted to the object through the objective lens 13 is directed coincides with or is in the vicinity of the target position (step S1). The control device 4 previously stores and holds XY coordinates of the target position on the object in the main memory 42 or the auxiliary storage device 43.

Next, the control device 4 detects, via the detection mechanism, a deviation between the target position and the position on the object to which the optical axis of the laser beam L emitted to the object through the objective lens is actually directed (step S2). That is, by reading a position on the X-axis scale 162 via the X-axis detection head 221, relative position coordinates of the table 22 and the object with respect to the laser irradiation device 1 along the X-axis direction are obtained. In addition, by reading a position on the Y-axis scale 172 via the Y-axis detection head 222, relative position coordinates of the table 22 and the object with respect to the laser irradiation device 1 along the Y-axis direction are obtained. At the same time, a distance between the Y-axis reference plane and the X-axis detection head 221 and a distance between the X-axis reference plane and the Y-axis detection head 222 are measured via the laser displacement meters 228 and 220.

The control device 4 performs feedback control to reduce the deviation between the target position and the position on the object to which the optical axis of the laser beam L is actually directed, which is detected in step S2 (step S3). In step S3, the XY stage 21 is operated to correct the positions of the table 22 and the object, and the Galvano scanners 11 and 12 are operated to correct the direction of the optical axis of the laser beam L.

In the present embodiment, the stage device 2 for an optical instrument is provided which includes the table 22 configured to support an object and to move together with the object; and the detection mechanism configured to detect the deviation between the target position to which the optical instrument (the laser irradiation device 1, the optical axis of the laser beam L) is to be directed on the object and the position to which the optical instrument 1 is actually directed. According to the present embodiment, the optical instrument can be accurately directed to a desired target position on the object supported by the moving table 22.

The present disclosure is not limited to the embodiment described above in detail. For example, the optical instrument to be combined with the stage device 2 according to the present disclosure is not limited to the laser irradiation device 1 that irradiates the object supported by the table 22 with the laser beam L. The optical instrument may be a microscope or a camera for observing or imaging a desired position on an object, an analyzation device that irradiates a desired position on an object with a light wave and receives reflected light, or the like.

In addition, the specific configuration of each unit, the procedure of processing, and the like can be variously modified without departing from the gist of the present disclosure.

1. An optical apparatus comprising:
an optical instrument;
a stage device including a table configured to support an object and to move together with the object to cause the optical instrument to be directed to any portion of a surface of the object; and
a detection mechanism configured to detect a deviation between a target position to which the optical instrument is to be directed on the object supported by the table and a position to which the optical instrument is actually directed.

2. The optical apparatus according to claim 1,
wherein the detection mechanism includes:
a scale provided in the optical instrument and extending in a direction parallel to a moving direction of the table; and
a detection head provided on the table and configured to read a position on the scale.

3. The optical apparatus according to claim 2,
wherein the table is movable in two-dimensional directions including an X-axis direction and a Y-axis direction intersecting the X-axis direction,
wherein the scale includes an X-axis scale extending in the X-axis direction and a Y-axis scale extending in the Y-axis direction, and
wherein the detection head includes an X-axis detection head supported to be relatively displaceable in the Y-axis direction with respect to the table and configured to read a position on the X-axis scale by facing the X-axis scale, and a Y-axis detection head supported to be relatively displaceable in the X-axis direction with respect to the table and configured to read a position on the Y-axis scale by facing the Y-axis scale.

4. The optical apparatus according to claim 3,
wherein the X-axis detection head is supported by a Y-axis block that is fixed to the table and moves along a Y-axis rail extending in the Y-axis direction,
wherein the Y-axis detection head is supported by an X-axis block that is fixed to the table and moves along an X-axis rail extending in the X-axis direction,
wherein a Y-axis reference plane extending in the Y-axis direction and an X-axis reference plane extending in the X-axis direction are set on the table, and
wherein the detection mechanism further includes an X-axis displacement measurement mechanism configured to measure a distance between the Y-axis block and the Y-axis reference plane, and a Y-axis displacement measurement mechanism configured to measure a distance between the X-axis block and the X-axis reference plane.

5. The optical apparatus according to claim 1, further comprising:
a control device configured to operate the table to reduce a deviation between a target position to which the optical instrument is to be directed on the object supported by the table and a position to which the optical instrument is actually directed.

6. The optical apparatus according to claim 1, further comprising:
a scanning device configured to irradiate any portion of a surface of the object with the laser beam, and adjust a position on the object to which the laser beam is directed by displacing an optical axis of the laser beam, and
wherein the stage device further comprises a control device configured to operate the scanning device to reduce a deviation between a target position to which the optical instrument is to be directed on the object supported by the table and a position to which the optical instrument is actually directed.
